(19) United States
(12) Patent Application Publication
(10) Pub. No.: US 2011/0264512 A1
(43) Pub. Date: Oct. 27, 2011

(54) USING STRUCTURED OFFER DATA TO CREATE KEYWORD BASED ADVERTISEMENTS

(75) Inventors: Lawrence William Colagiovanni, Issaquah, WA (US); Rupesh Mane, Redmond, WA (US); Arun Sacheti, Sammamish, WA (US); Saurab Nog, Sammamish, WA (US); Derek Keng Choi, Redmond, WA (US); Phanindra Kanumuri, Issaquah, WA (US)

(73) Assignee: MICROSOFT CORPORATION, Redmond, WA (US)

(21) Appl. No.: 12/767,402

(22) Filed: Apr. 26, 2010

(51) Int. Cl. G06Q 30/00; G06Q 10/00

(52) U.S. Cl. 705/14.43; 705/14.44; 705/14.45; 705/14.52

(57) ABSTRACT

As a result of the system, effective advertisements may be created using only the structured data from the seller. The difficulty of determining keywords to bid on is eliminated as the system determines the keywords from the structured data. In addition, the structure data is used to create the text and images for an advertisement. The seller supplies the sales data and the system creates advertisement based on the sales data. In addition, the system may be able to create and adjust bids on keywords to better optimize sales.

### BACKGROUND

This Background is intended to provide the basic context of this patent application and it is not intended to describe a specific problem to be solved.

Modern commerce often happens by searching a network, such as the Internet, using a search engine for a specific item. Many sellers are skilled at manufacturing goods or by providing services but are less skilled at having their goods and services noticed by a search engine or having their good and services advertised on a search engine in response to a search.

In response, some sellers have become skilled at providing good or service data to a search engine such that their goods and services may be displayed in response to a search, especially a shopping search. However, creating useful advertisements in response to certain keywords has remained a challenge to many providers of goods and services.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A method of electronically analyzing structured offers from a vendor to create keyword based advertisements for the vendor is disclosed. Offers from the vendor are reviewed. Attributes are extracted from the offers and submitted to an analysis system. A keyword list is received from the analysis system where the keyword list includes the attributes and related keyboards to the attributes. An electronic advertising campaign is created, including advertising copy and illustrations. A query with keywords is received. The query is submitted to a query keyword analysis system. A query keyword list is then received from the query keyword analysis system where the query keyword list contains query keywords and related query keyboards to the query keywords. A query list is created where the query list contains query keywords and related query keyword. It may be determined if the query list is sufficiently similar to the keyword list. If the query list is determined to be sufficiently similar to the keyword list, an advertisement for the vendor may be created. Related attributes, keywords and images may be added to the advertisement, advertising text may be created to go with the attributes and the attributes, keywords and images may be displayed as an advertisement. It also may be determined how much to bid for an advertisement. A bid may be issued in a bid amount for a keyword, an advertising placement may be determined, the success of the bid may be determined, a click through rate may be checked, a buying rate may be checked, the bid amount may be adjusted and the adjustment may repeat.

### BRIEF DESCRIPTION OF THE DRAWINGS

FIG. 1 is an illustration of a computing device;

FIG. 2 is an illustration of a method of electronically analyzing structured offers from a vendor to create keyword based advertisements for the vendor;

FIG. 3 is an illustration of step in a sample analysis system;

FIG. 4 is an illustration of a method of adjusting the advertisement based on feedback;

FIG. 5 illustrates a method of determining how much to bid for an ad;

FIG. 6 is an illustration of structured data; and

FIG. 7 is an illustration of an advertising template.

### SPECIFICATION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

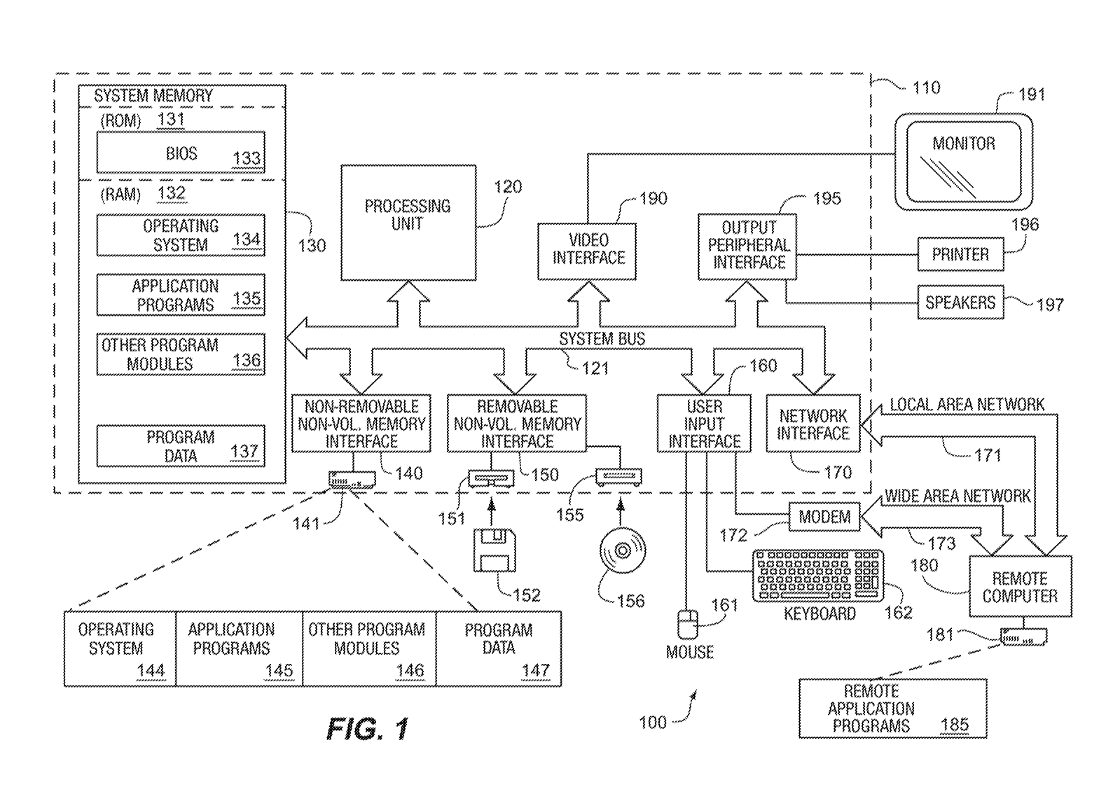

FIG. 1 illustrates an example of a suitable computing system environment 100 that may operate to execute the many embodiments of a method and system described by this specification. It should be noted that the computing system environment 100 is only one example of a suitable computing environment and is not intended to suggest any limitation as to the scope of use or functionality of the method and apparatus of the claims. Neither should the computing environment 100 be interpreted as having any dependency or requirement relating to any one component or combination of components illustrated in the exemplary operating environment 100.

With reference to FIG. 1, an exemplary system for implementing the blocks of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120.

The computer 110 may operate in a networked environment using logical connections to one or more remote computers, such as a remote computer 180, via a local area network (LAN) 171 and/or a wide area network (WAN) 173 via a modem 172 or other network interface 170.

Computer 110 typically includes a variety of computer readable media that may be any available media that may be accessed by computer 110 and includes both volatile and nonvolatile media, removable and non-removable media. The system memory 130 includes computer storage media in the form of volatile and/or nonvolatile memory such as read only memory (ROM) 131 and random access memory (RAM) 132. The ROM may include a basic input/output system 133 (BIOS). RAM 132 typically contains data and/or program modules that include operating system 134, application programs 135, other program modules 136, and program data 137. The computer 110 may also include other removable/non-removable, volatile/nonvolatile computer storage media such as a hard disk drive 141 a magnetic disk drive 151 that reads from or writes to a magnetic disk 152, and an optical disk drive 155 that reads from or writes to an optical disk 156. The hard disk drive 141, 151, and 155 may interface with system bus 121 via interfaces 140, 150.

A user may enter commands and information into the computer 110 through input devices such as a keyboard 162 and pointing device 161, commonly referred to as a mouse, trackball or touch pad. Other input devices (not illustrated) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device may also be connected to the system bus 121 via an interface, such as a video interface 190. In addition to the monitor, computers may also include other peripheral output devices such as speakers 197 and printer 196, which may be connected through an output peripheral interface 195.

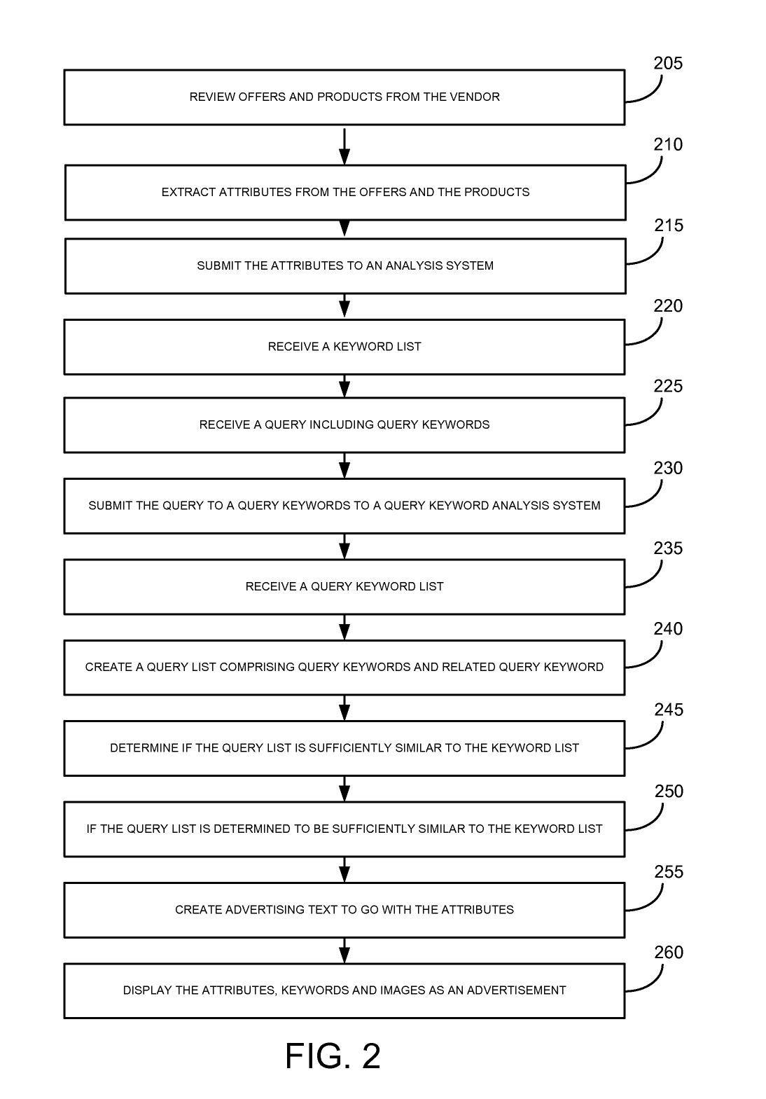

FIG. 2 illustrates a method of electronically analyzing structured offers from a vendor to create keyword based advertisements for the vendor. In modern times, users often search for good and services by using a search engine. The search engine usually searches a network, such as the Internet, and provides relevant results to the user's query. The results are usually presented in a relevance order as determined by the search engine. At the same time, advertisements are also displayed in response to the query. Logically, the higher a sellers goods are in response to a query, either as search results or as advertisements, the better the results will usually be for the seller.

Some networks are more specific, such as shopping based networks. On these networks, the results are more targeted to selling goods and services. Users are usually looking for prices for a specific good or service or for comparable goods and services. In these situations, sellers will often submit data to a search engine on good and services for sale. The data may be structured in a format that makes it easier for the search engine to locate and display the goods.

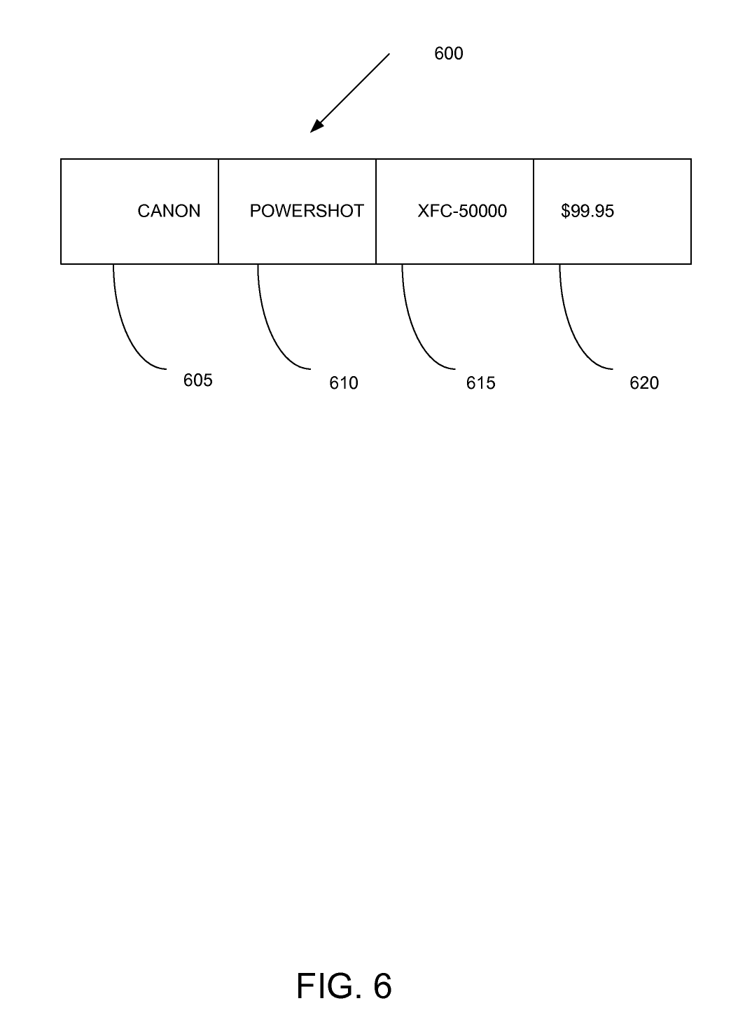

At block 205, offers from a vendor may be reviewed. In some situations, offers may be received from the vendor (and may be stored) as structured data. FIG. 6 may be an illustration of structured data 600. Structured data 600 may be, as the name implies, data that fits a structure. For example, the first field of data 605 may be a manufacturer name of a product, the second name 610 may be a model name for a product, the third field may be a model number 615, the fourth field 620 may be a price, etc. In this way, the structured data 600 may be quickly searched and indexed by the search engine. In addition, changes by a seller may be made quickly and easily and the change does not have to be located by the search engine but can be communicated to the search engine to ensure it is found.

In some instances, the data may need to be parsed or even normalized. For example, the quantity and price provided by a seller may be for three units but most users will likely search for a single unit. The data may be normalized such that the quality and price, for example, may be the same for all offers.

At block 210, attributes may be extracted from the seller offers. Some example attributes but not limitations may include a merchant name, offer title, offer description, brand, product title, product category, product sku, product color and product price. Of course, other attributes are possible depending on the offer, the desires of the seller, etc., and are contemplated.

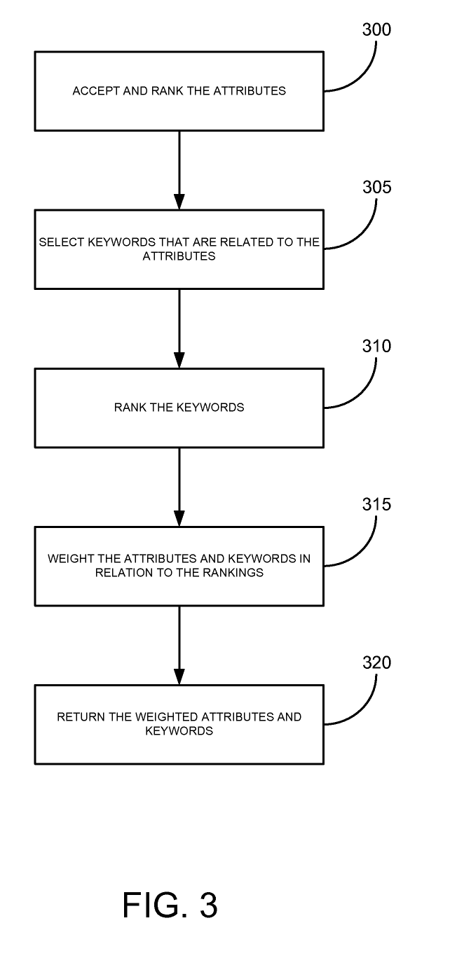

At block 215, the attributes may be submitted to an analysis system. At a high level, an analysis system may extract from the attributes terms that might be useful in responding to a query or to be placed in an advertisement. FIG. 3 illustrates some steps taken by a sample analysis. The steps are exemplary and are not meant to be limitations.

At block 300, the attributes may be accepted by the analysis system. The attributes may be communicated in any useful manner, such as a flat file, a common separated file, as an array, etc. It should be noted that not all words or terms in the query may be attributes. For example, the word “the” may be part of a query such as “The best running shoe.” The word “the” would not be further analyzed. In one embodiment, a list of common terms that may be part of a query but do not need further analysis may be created and words on the “do not review” list may be skipped. Similar lists may be used to classify all the terms. For example, the query “Adidas Stan Smith” is for a specific shoes and a useful advertisement should be for Adidas Stan Smith shoes and alternative shoes may be limited.

In addition, the attributes may be ranked for relevance and for the ability to provide useful keywords. The ranking may be accomplished in a variety of ways. In one embodiment, past experience is used to rank the attributes such as past success in providing useful keywords, results of consumer surveys, results of trend analysis of search queries, results of past terms click response rates and results of past terms purchase rates. In another embodiment, a training set of queries, attributes and ranking is used to train the system to recognized attributes and to rank them based on the rankings in the training set. Of course, additional ways of ranking attributes are possible and are contemplated.

At block 305, keywords may be selected that are related to the attributes. For example, if the attribute is running shoe, a similar keyword may be trainer, jogging, distance, mileage, and shock absorbing. The keywords may be useful in determining what query words should be responded to with the good or services of the seller. The rankings from block 300 may be used to help pick the keywords. For example, if the search is for a Canon camera lens rather than a Canon camera, the attribute may be “lens” as opposed to “camera” and the keyword of “lens” would be of great importance. Logically, keywords related to the heaviest weighted attribute may be more prevalent and given more importance.

In one embodiment, a list of related keywords is maintained for attributes. The list may be created by past experience. In another embodiment, the list may reflect an intended audience, such as premium shoe shoppers. In another embodiment, the list is based on past queries by users. Of course, other methods of analyzing the attributes and finding relevant keywords are possible and are contemplated. In some embodiments, the keywords and the attributes are returned.

In another embodiment, at block 310, the keywords may be ranked. The ranking may be based several factors, including, but not limited to, past success in matching the keywords and attributes to queries, results of consumer surveys, results of trend analysis of search queries, results of past terms click response rates and results of past terms purchase rates. Of course, other ways of ranking the results are possible and are contemplated.

At block 315, the attributes and/or keywords may have weights added in relation to the rankings. For example, if the ranking from block 310 determined that a first keyword was very highly ranked, the first keyword may be given a large weight. The weight may be used for a variety of reasons, such as determine how aggressively to bid on a keyword or whether the keyword should be included in an advertisement. Of course, other uses of the weights may be possible and are contemplated.

At block 320, the weighted attributes and keywords may be returned. The return may occur in any common way in modern computing methodology, such as populating a file, changing the value of a variable, etc.,

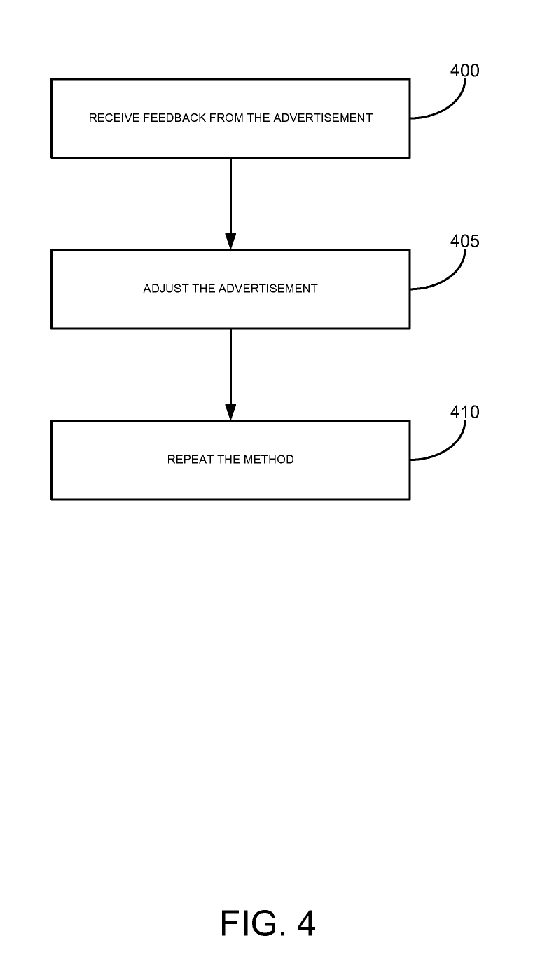

In some embodiments, a type of feedback loop may be used to monitor the created advertisement. The feedback loop may monitor the success or failure of the advertisement and may modify the advertisement based on the success or failure of the advertisement. FIG. 4 illustrates a method of adjusting the advertisement based on feedback.

At block 400, feedback may be received from the advertisement where feedback may include a click through rate and/or a purchase rate. A click through rate may indicate the number or percentage of times that an advertisement is selected when displayed. A purchase rate may indicate a number or percentage of times that a purchase was made based on an advertisement. The concept is that an effective advertisement should have a higher click through and purchase rate than an ineffective advertisement. An ineffective advertisement likely needs to be adjusted in some way, such as changing keywords in the ad, displaying the advertisement in response to different queries, etc.

At block 405, the advertisement may be adjusted. The adjustment may be, for example and not limitation, adding new terms, removing some terms, changing the order of the terms and adding additional graphics. The purpose of the adjustment is to make the advertisement more effective by having more people select the advertisement or have more people make a purchase based on the ad. At block 410, the method of adjusting the advertisement may repeat, meaning the adjustment may be ongoing.

Referring again to FIG. 2, at block 220, a keyword list may be received from the analysis system. The keyword list may include attributes and related keyboards to the attributes where the related keywords are additional terms related to the attribute. As stated previously, as an example, a search for running shoes may result in trainers being a keyword as trainers are often synonymous with running shoes.

In some embodiments, the keywords may be geographically adjusted. Some words have different meanings in different parts of the world. As an example, the term “french fries” may be a term used in the United States, while the term “chips” may be used in the United Kingdom and “pommes frites” may be used in France. The keyword list may be modified to find relevant keywords based on the location of the request. The location of the request may be determined in several known ways, such as observing the IP address of the request or requiring a user to log in and state a location. Further, the keywords may be even more localized, such as by state, city, neighborhood, etc. In addition, the related keywords may be creating in any language.

An electronic advertising campaign may be created. The advertising campaign may contain several elements. Text for the advertisement may be created. The text may contain the keywords and attributes in sentences or as bullet points. Images may also be included to help attract users or generate interest. The campaign may have a variety of elements and levels. In some levels, the advertisement may just be text. In other levels, the advertisement may include text and images. In yet another level, the advertisement may include text, images, video and sound. The levels may be priced at different costs or may relate to the desires of a seller or the nature of the good or service to be sold.

At block 225, a query may be received. The query may contain keywords such as “Canon Powershot” or “Nike running shoe.” The query may be a request for information or may be made specifically to a shopping site and may be a request for the lowest prices for a good or service. Queries or text entered into a search engine are well known.

At block 230, the query may be submitted to a query keyword analysis system. FIG. 3 may illustrate what occurs in a sample analysis system. As described in relation to FIG. 3, the analysis system may take the query, break it down into words or phrases and attempt to find similar words or phrases that may be useful in creating an effective advertisement.

An effective advertisement may be determined in a variety of ways, such as a good click through rate, a good purchase rate, etc. In some embodiments, the rates may be compared to a baseline. In other embodiments, the rates may be compared to a prediction while in other embodiments, the rates may be compared to past rates. Of course, the effectiveness may depend on the goods or services being sold, the desires of the seller, past performance, etc.

At block 235, a query keyword list may be received from the query keyword analysis system. The query keyword list may contain query keywords and related query keyboards to the query keywords where related keywords are additional terms related to the query keywords. The related words may be stored as a file and searched using the query keyword list. In another embodiment, the related words may be stored in a tree like fashion and the various terms in the query keyword list may proceed down the tree (or up the tree) collecting terms that may indicate that the query was related to the term.

At block 240, a query list may be created which may include query keywords and related query keyword where related query keyword may include additional terms related to the query keywords.

At block 245, it may be determined if the query list is sufficiently similar to the keyword list. For example, if the query was for running shoes, the query list may contain trainers, jogging shoes, and marathon shoes. The keyword list may contain terms related to the sale data received from the vendor. For example, the seller may sell cameras and “Canon” may be in the keyword list as may be “Powershot” and “Rebel” where Powershot and Rebel may be types of Canon cameras. Other terms may include “Nikon” and “Sony” which are also makers of cameras. The lists may appear as follows:

| QUERY LIST | KEYWORD LIST |
|---|---|
| Running | Canon |
| Shoes | Powershot |
| Trainers | Rebel |
| Jogging | Nikon |
| Marathon | Sony |

As can be seen, there are no matches in the above list, meaning it is likely that the query and the keyword list are not sufficiently similar. As another example, the seller may sell New Balance Running Shoes. The query list/keyword list comparison may be as follows:

| QUERY LIST | KEYWORD LIST |
|---|---|
| Running | New |
| Shoes | Balance |
| Trainers | Running |
| Jogging | Shoes |
| Marathon | |

As can be seen, “running” and “shoes” appear in each list, meaning it is likely that the query and the keyword list are sufficiently similar. In one embodiment, a single matching term may be sufficient for the query list and the keyword list to be considered sufficiently similar. In another embodiment, a more sophisticated system may be used to compare the lists. Also, the keywords may be more than a single word. The keywords maybe be a combination of words or phrases.

At block 250, if the query list is determined to be sufficiently similar to the keyword list, an advertisement may be created. The method may identify related attributes, keywords and images for the advertisement.

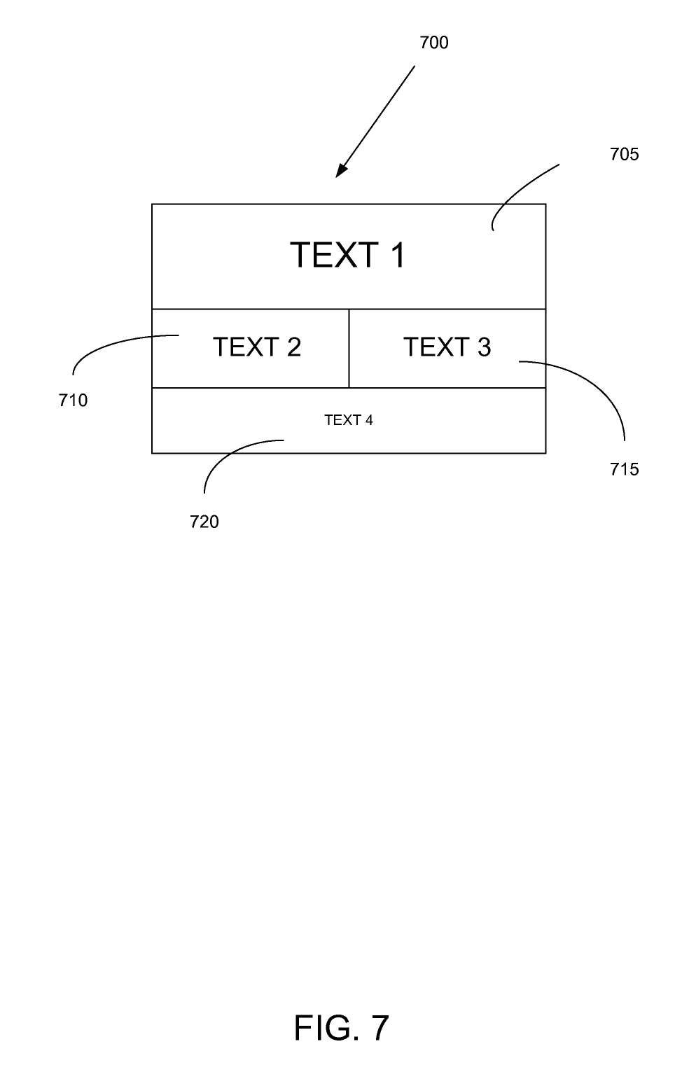

At block 255, advertising text may be created to go with the attributes. The text may contain terms from the query list and the keyword list along with words to entice a buyer such as “sale” or “discount.” In one embodiment, a template or form is used. FIG. 7 may be an illustration of a template 700. The template 700 may be filled in with the data from query list and the keyword list and the template 700 may contain some standard text. For example and not limitation, the brand name 705, model name 710, price 715 and web site 720 for a good may be known from the structured data 600 from the seller. The template 700 may call for the brand name 705, model name 710, price 715 and web site 720 to be displayed in a large font at the top of the display.

As another example, if a vendor is extremely price competitive, a price template 700 may be used which may emphasize the price by displaying the price very prominently, such as in bold or in a large font. The template 700 used may reflect the query. For example, if the query has the word “sale” the template 700 may emphasize the low price of the good or service. If the query has the word “best” the template 700 may emphasize the quality of the good or service. In some embodiments, the terms from the query may be repeated.

At block 260, the attributes, keywords and images may be displayed as an advertisement. The display may be based on the template 700 where terms from the query are displayed in a larger font than other terms. The image may be from the seller, may be an image from a manufacturer or may be a standard image. If an image is not available, the template 700 may leave the space blank or may display another eye catching image.

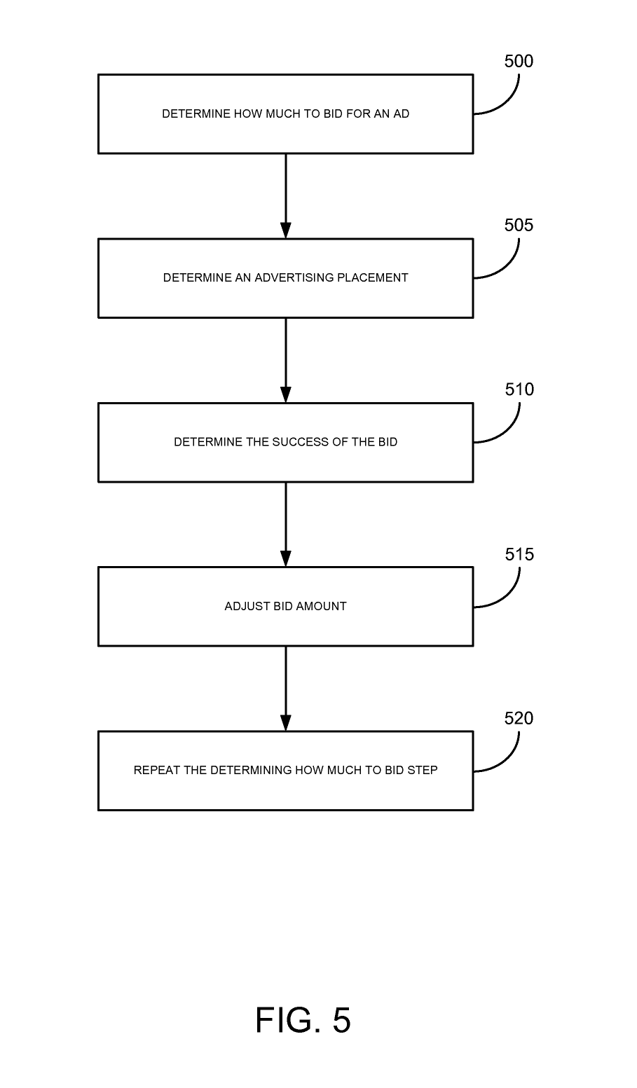

In one embodiment, the amount to be bid to place an advertisement in a prominent spot related to the search may be determined. FIG. 5 may illustrate one possible method of determining how much to bid for an ad. At block 500, a bid may be issued in a bid amount for a keyword. The bid may be selected from previous experience or may be at a minimum which can be raised for later bids. In some embodiments, the sellers may indicate the minimum or maximum bid amount. Commonly, the seller that bids the most for a keyword gets the best placement on related queries. At the same time, a bid that is significantly higher than other bids is wasting money.

At block 505, an advertising placement may be determined. The placement may refer to the location on the display of the advertisement in relation to the search results of the search engine. A winning bid may be displayed in the most prominent location on a search result page with the second highest bid receiving the second best location, etc. Often, there may be a correlation between advertisement location and advertisement success.

At block 510, the success of the bid may be determined. The success may be determined in a variety of ways. As described previously, a click through rate may be determined as a success indicator. In another embodiment, a buying rate may be determined and used as a success indicator. The click through rate may be compared to a baseline, past rates, desired rates or predicted rates to determine the success.

At block 515, the bid amount may be adjusted. If the success of the bid was not satisfactory, the bid amount may be raised. If the success of the bid was satisfactory, the bid amount may kept the same or even lowered to ensure that the seller is not paying too much.

At block 520, the determining how much to bid step may be repeated. In other words, the method may be repeated and the bid amount further adjusted up or down to obtain the optimal combination of keyword bid and resulting sales. More specifically, bids that are too low will result in advertisements that are not displayed prominently and will not be satisfactory while bids that are too high may result in sales but may be so expensive that the profit from the sale may be lost.

In some embodiments, a cash back offer may be made when purchasing items through a specific web site. The cash back percentage also may be modified in a similar way to the key word bids as described in FIG. 5. More specifically, in one embodiment, the cash back may be set at an initial level, the advertisement success may be determined and the cash back rate may be adjusted upward or downward in order to have an optimal amount of sales in view of the as cost.

As a result of the system, effective advertisements may be created using only the structured data 600 from the seller. The difficulty of determining keywords to bid on is eliminated as the system determines the keywords from the structured data 600. In addition, the structure data is used to create the text and images for an advertisement. The seller supplies the sales data and the system creates advertisement based on the sales data. In addition, the system may be able to create and adjust bids on keywords to better optimize sales.

In conclusion, the detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

1. A method of electronically analyzing structured offers from a vendor to create keyword based advertisements for the vendor comprising:
reviewing offers from the vendor;
extracting attributes from the offers;
submitting the attributes to an analysis system;
receiving from the analysis system a keyword list comprising the attributes and related keyboards to the attributes wherein related keywords are additional terms related to the attribute;
creating an electronic advertising campaign comprising:
receiving a query comprising query keywords;
submitting the query to a query keywords to a query keyword analysis system;
receiving from the query keyword analysis system a query keyword list comprising the query keywords and related query keyboards to the query keywords wherein related keywords are additional terms related to the query keywords;
creating a query list comprising query keywords and related query keyword wherein related query keyword comprise additional terms related to the query keywords;
determining if the query list is sufficiently similar to the keyword list;
if the query list is determined to be sufficiently similar to the keyword list:
creating an advertisement for the vendor comprising:
identifying related attributes, keywords and images;
creating advertising text to go with the attributes;
displaying the attributes, keywords and images as an advertisement.

2. The method of claim 1, wherein the offers from the vendor are stored and communicated as structured data.

3. The method of claim 1, wherein reviewing offers from the vendor further comprises parsing and normalizing the data.

4. The method of claim 1, wherein attributes further comprise at least one selected from a group comprising: merchant name, offer title, offer description, brand, product title, product category, product sku, product color.

5. The method of claim 1, wherein the analysis system executes steps comprising:
accepting the attributes;
selecting keywords that are related to the attributes;
returning the keywords and the attributes.

6. The method of claim 5, further comprising:
ranking the attributes based on at least one selected from a group comprising:
past success in matching the keywords and attributes to queries;
results of consumer surveys;
results of trend analysis of search queries;
results of past terms click response rates; and
results of past terms purchase rates;
weighting the attributes in relation to the rankings; and
returning the weighted attributes and
ranking the keywords based on at least one selected from a group comprising:
relation to the most heavily weighted attributes;
past success in matching the keywords and attributes to queries;
results of consumer surveys;
results of trend analysis of search queries;
results of past terms click response rates; and
results of past terms purchase rates;
weighting the keywords in relation to the rankings; and
returning the weighted keywords.

7. The method of claim 6, further comprising:
receiving feedback from the advertisement wherein feedback comprises at least one selected from a group comprising click through rate and purchase rate;
adjusting the advertisement comprising at least one selected from a group comprising:
adding new terms;
removing some terms;
changing the order of the terms; and
adding additional graphics;
repeating the method.

8. The method of claim 1, further comprising:
determining how much to bid for an advertisement comprising;
issuing a bid in a bid amount for a keyword;
determining an advertising placement;
determining the success of the bid comprising:
checking a click through;
check a buying rate;
adjusting bid amount;
repeating the determining how much to bid step.

9. The method of claim 1, wherein displaying the attributes, keywords and images as an advertisement further comprises using a template and filling in the template with the keyword list.

10. A computer storage medium physically configured according to computer executable instructions for electronically analyzing structured offers from a vendor to create keyword based advertisements for the vendor, the instructions comprising instructions for:
reviewing offers from the vendor;
extracting attributes from the offers;
submitting the attributes to an analysis system;
receiving from the analysis system a keyword list comprising the attributes and related keyboards to the attributes wherein related keywords are additional terms related to the attribute;
creating an electronic advertising campaign comprising:
receiving a query comprising query keywords;
submitting the query to a query keywords to a query keyword analysis system;
receiving from the query keyword analysis system a query keyword list comprising the query keywords and related query keyboards to the query keywords wherein related keywords are additional terms related to the query keywords;
creating a query list comprising query keywords and related query keyword wherein related query keyword comprise additional terms related to the query keywords;
determining if the query list is sufficiently similar to the keyword list;
if the query list is determined to be sufficiently similar to the keyword list:
creating an advertisement for the vendor comprising:
identifying related attributes, keywords and images;
creating advertising text to go with the attributes;
displaying the attributes, keywords and images as an advertisement.

11. The computer storage medium of claim 10, wherein attributes further comprise at least one selected from a group comprising: merchant name, offer title, offer description, brand, product title, product category, product sku, product color.

12. The computer storage medium of claim 10, wherein the analysis system executes steps comprising:
accepting the attributes;
selecting keywords that are related to the attributes;
returning the keywords and the attributes.

13. The computer storage medium of claim 12, further comprising:
ranking the attributes based on at least one selected from a group comprising:
past success in matching the keywords and attributes to queries;
results of consumer surveys;
results of trend analysis of search queries;
results of past terms click response rates; and
results of past terms purchase rates;
weighting the attributes in relation to the rankings; and
returning the weighted attributes; and
ranking the keywords based on at least one selected from a group comprising:
relation to the most heavily weighted attributes;
past success in matching the keywords and attributes to queries;
results of consumer surveys;
results of trend analysis of search queries;
results of past terms click response rates; and
results of past terms purchase rates;
weighting the keywords in relation to the rankings; and
returning the weighted keywords.

14. The computer storage medium of claim 13, further comprising:
receiving feedback from the advertisement wherein feedback comprises at least one selected from a group comprising click through rate and purchase rate;
adjusting the advertisement comprising at least one selected from a group comprising:
adding new terms;
removing some terms;
changing the order of the terms; and
adding additional graphics;
repeating the method.

15. The computer storage medium of claim 10, further comprising:
determining how much to bid for an advertisement comprising;
issuing a bid in a bid amount for a keyword;
determining an advertising placement;
determining the success of the bid comprising:
checking a click through;
check a buying rate;
adjusting bid amount;
repeating the determining how much to bid step.

16. The computer storage medium of claim 10, wherein displaying the attributes, keywords and images as an advertisement further comprises using a template and filling in the template with the keyword list.

17. A computer system comprising a processor physically configured according to computer executable instructions, a memory physically configured according to computer executable instructions and an input/output circuit, computer executable instructions for electronically analyzing structured offers from a vendor to create keyword based advertisements for the vendor, the instructions comprising instructions for:
reviewing offers from the vendor;
extracting attributes from the offers wherein attributes further comprise at least one selected from a group comprising: merchant name, offer title, offer description, brand, product title, product category, product sku, product color;
submitting the attributes to an analysis system;
receiving from the analysis system a keyword list comprising the attributes and related keyboards to the attributes wherein related keywords are additional terms related to the attribute;
creating an electronic advertising campaign comprising:
receiving a query comprising query keywords;
submitting the query to a query keywords to a query keyword analysis system;
receiving from the query keyword analysis system a query keyword list comprising the query keywords and related query keyboards to the query keywords wherein related keywords are additional terms related to the query keywords;
creating a query list comprising query keywords and related query keyword wherein related query keyword comprise additional terms related to the query keywords;
determining if the query list is sufficiently similar to the keyword list if the query list is determined to be sufficiently similar to the keyword list:
determining how much to bid for an advertisement comprising;
issuing a bid in a bid amount for a keyword;
determining an advertising placement;
determining the success of the bid comprising:
checking a click through;
check a buying rate;
adjusting bid amount;
repeating the determining how much to bid step;
creating an advertisement for the vendor comprising:
identifying related attributes, keywords and images;
creating advertising text to go with the attributes;
displaying the attributes, keywords and images as an advertisement wherein displaying the attributes, keywords and images as an advertisement further comprises using a template and filling in the template with the keyword list.

18. The computer system of claim 17, wherein the analysis system executes steps comprising:
accepting the attributes;
selecting keywords that are related to the attributes;
returning the keywords and the attributes.

19. The computer system of claim 18, further comprising:
ranking the attributes based on at least one selected from a group comprising:
past success in matching the keywords and attributes to queries;
results of consumer surveys;
results of trend analysis of search queries;
results of past terms click response rates; and
results of past terms purchase rates;
weighting the attributes in relation to the rankings; and
returning the weighted attributes and ranking the keywords based on at least one selected from a group comprising:
relation to the most heavily weighted attributes;
past success in matching the keywords and attributes to queries;
results of consumer surveys;
results of trend analysis of search queries;
results of past terms click response rates; and
results of past terms purchase rates;
weighting the keywords in relation to the rankings; and
returning the weighted keywords

20. The computer system 17, further comprising:
receiving feedback from the advertisement wherein feedback comprises at least one selected from a group comprising click through rate and purchase rate;
adjusting the advertisement comprising at least one selected from a group comprising:
adding new terms;
removing some terms;
changing the order of the terms; and
adding additional graphics;
repeating the method.
